(19) United States
(12) Patent Application Publication
(10) Pub. No.: US 2012/0255349 A1
(43) Pub. Date: Oct. 11, 2012

(54) MICRO-POWER SYSTEMS

(75) Inventors: Valer Pop, Leuven (BE); Hubregt Jannis Visser, Leuven (BE); Robertus Van Schaijk, Eindhoven (NL)

(73) Assignee: Stichting IMEC Nederland, Eindhoven (NL)

(21) Appl. No.: 13/441,759

(22) Filed: Apr. 6, 2012

Related U.S. Application Data
(60) Provisional application No. 61/472,573, filed on Apr. 6, 2011.

(51) Int. Cl. B60C 23/04; H02J 1/10

(52) U.S. Cl. 73/146.5; 307/43

(57) ABSTRACT

A micro-power system and a tire pressure monitoring system that includes an energy harvesting module and a computing device are disclosed. In one aspect, the energy harvesting module comprises an energy harvesting unit having a combined vibration energy/RF energy harvester. A single sensing element is used for both vibration energy harvest and for RF communication including RF energy harvesting. Energy harvested is transmitted to power management module which powers components of the energy harvesting module. Data relating to sensor output from the single sensing element is transmitted to a microcontroller and transmitted to a microprocessor unit on the computing device.

### CROSS-REFERENCE TO RELATED APPLICATION

This application is related to U.S. Provisional Application Ser. No. 61/472,573, filed Apr. 6, 2011, the contents of which are herein incorporated by reference in its entirety.

### BACKGROUND OF THE INVENTION

1. Field of the Invention

The present invention relates to improvements in or relating to micro-power systems, and is more particularly, although not exclusively, concerned with micro-power systems that are used to provide electrical power to wireless and self-powered monitoring sensor devices, for example, tire pressure monitoring systems.

2. Description of the Related Technology

Monitoring sensors are commonly employed in many applications to measure a set of specific parameters, such as, pressure, temperature, strain, etc., in a location of interest. Depending on the particular application, the requirements regarding the delivery of the system power to the sensor and data transfer from the sensor can vary. Conventionally, system power and data transfer can be implemented using legacy wiring. However, given the complexity and cost of wiring, wireless and, preferably, self-powered monitoring sensors are preferred.

One particular application of interest is in the field of automotive technology, for example, as part of an autonomous tire pressure monitoring system (TPMS) or “intelligent tire” sensor system which has extra functionality besides the traditional measurement of pressure and temperature, for example, acceleration, forces, etc., acting on or applied to the tire. In this case, the TPMS must be completely self-powered, since legacy wiring cannot be used. This is achieved, by using a battery to power up the entire system. However, the battery in the TPMS effectively needs to be replaced at certain intervals, and such replacement is not always desirable due to the amount of effort involved in dismounting the whole system. In addition, battery-powered systems suffer from reliability problems, which can be exacerbated by the forces applied to the tire while in motion. Moreover, the monitoring sensor needs to be able to transmit the data acquired wirelessly to the mainframe of the system.

Several wireless and battery-less systems are available in the state-of-the-art for tire pressure monitoring systems. One wireless and battery-less sensor device is described in US-A-2009/0303076. The wireless sensor device contains a self-powered sensor and a radio frequency transmitter. The sensor utilizes a vibration energy harvesting module to power the sensor. A radio frequency energy harvester is used to power the radio frequency transmitter for backscatter modulation data communication.

In KR-A-2006095697, a surface acoustic wave (SAW) based passive radio sensing system using piezoelectric power and wireless power transmission is provided to semi-permanently detect a tire pressure in real time by using piezoelectric power and wireless power transmission. In US-A-2011/0012723, a system mounted in the tire for monitoring TPMS that combines a battery, a fuel cell, a radiation source, a super-capacitor, a piezoelectric transducer, a thermo-electric transducer, a radio frequency (RF) energy harvesting device, and combinations thereof is described. Similar combinations of different energy harvesting devices are also described in US-A-2005/0186994, WO-A-2010/033012, US-A-2009/0174361 and US-A-2008/0054638.

### SUMMARY OF CERTAIN INVENTIVE ASPECTS

It is therefore an object of some aspects to provide an improved micro-power system which harvests energy.

It is another object of some aspects to provide an improved tire pressure monitoring system.

In accordance with a first aspect a micro-power system comprises a mechanical energy harvester unit; a power management module for receiving power generated by the mechanical energy harvester unit; and a radio frequency energy harvester unit; wherein the mechanical energy harvester and the radio frequency energy harvester unit share at least one sensor element.

In some aspects, combining the mechanical energy harvester and the radio frequency energy harvester, the micro-power device can readily be incorporated into other systems where no external power connections can be implemented. Moreover, such micro-power devices can also be used in environments where it is not possible to utilize other power sources, for example, batteries.

The mechanical energy harvester unit may comprise at least one strain gauge. In one embodiment, each strain gauge comprises a metallic foil formed on a dielectric substrate. In a preferred embodiment, each strain gauge includes an antenna. Furthermore, each strain gauge may include a rectifier.

In accordance with another aspect, there is provided a tire pressure measurement system comprising at least one pressure sensor configured for location within a tire; a first processor for processing signals output from each pressure sensor; a second processor configured for mounting on a vehicle; at least one communications link between the first processor and the second processor; and a micro-power system as described above.

Certain inventive aspects relating to a micro-power system for harvesting (scavenging) energy from the environment to provide the electrical power required for operating a monitoring sensor device will be described. The micro-power system comprises a harvesting unit and a power management circuit containing an integrated storage element for storing energy from the harvester unit. The harvesting unit may be “flexible”, that is, a strain gauge, or a micro-electromechanical system (MEMS) device.

In one aspect all features of the micro-power system, such as, the power generation (harvester/scavenging) unit, energy conversion unit and energy storage, are fully integrated in a single flexible package.

The micro-power system can be a part, but not limited to, of a tire pressure monitoring system (TPMS), whereby the micro-power system further comprises a sensor unit with at least one sensor for measuring specific parameters, such as, pressure, for example, in a vehicle tire, acceleration forces, for example, of the vehicle on which the tire being monitored is located, temperature, strain, for example, material strain, and deformation, for example, material deformation.

The harvesting unit can be configured to generate power mechanically by motion, for example, vehicle tire rotation, vibration, for example, vehicle tire vibration during motion, or strain, for example, vehicle tire deformation during contact with road surface. The micro-power system may also include a radio frequency (RF)-piezoelectric harvester/sensor module as a harvesting unit for generating energy using an external RF power source, for example, an RF beam, in the case where the mechanically generated energy, for example, due to motion, pressure, strain, etc., is not sufficient or absent.

The RF-piezoelectric harvester/sensor module and mechanical harvesting unit may be fabricated as one integrated device or integrated as separate modules in the micro-power system.

The electrodes of the mechanical harvesting module may also be used as an RF antenna configured for harvesting energy from an external RF power source.

The power management module of the micro-power system is configured to convert the energy flow from the harvesting unit into energy suitable for directly powering the load, that is, the sensor.

The harvesting and storage units can be additionally used as an accelerometer measurement system. Vehicle motion and speed are detected by comparing the voltage generated by the harvesting unit with a certain voltage threshold. This eliminates the need for separate additional accelerometer devices.

The micro-power system may further comprise a radio system arranged for wireless communication with an end-user or main frame computer. Additionally, the radio system may communicate with a processor on board a vehicle when it is implemented as part of a TPMS.

The communication signal generated by the micro-power system may also serve as a “wake-up” signal to turn on the entire monitoring sensor module, for example, from the moment motion is detected, the micro-power system may send a wake-up signal for activating other components of the module. Alternatively, from the moment RF signals are being generated by an end-user or other component, for example, a processor on board a vehicle, the micro-power system may be activated. This acts as a “wake-up” signal where turning on a vehicle may generate RF signals which can be harvested by the micro-power system to wake up the harvester/sensor module.

The communication signal strength may also be used for identifying the location of the micro-power system sending the signal, for example, sensor modules are typically placed at different locations, being at a different distances with respect to the main frame computer or end user so that the strength of the signals being received will be different from one another.

### BRIEF DESCRIPTION OF THE DRAWINGS

For a better understanding of the present invention, reference will now be made, by way of example only, to the accompanying drawings.

FIG. 1 illustrates a first embodiment of a tire pressure monitoring system (TPMS) in accordance with an embodiment.

FIG. 2a illustrates tire contact with a road surface where a harvesting unit comprising a strain gauge mounted on a flexible deformable element is utilized.

FIG. 2b illustrates a graph of strain against time for the embodiment shown in FIG. 2a.

FIG. 3a illustrates tire contact with a road surface .where a harvesting unit comprising a micro-electromechanical system (MEMS) device is utilized.

FIG. 3b illustrates a graph of acceleration or impact against time for the embodiment shown in FIG. 3a.

FIG. 4 illustrates a second embodiment of TPMS in accordance an embodiment.

FIG. 5 illustrates a third embodiment of a TPMS in accordance with an embodiment.

FIG. 6 illustrates an implementation of a harvesting unit in accordance with an embodiment.

### DETAILED DESCRIPTION OF CERTAIN INVENTIVE EMBODIMENTS

The disclosed technology will be described with respect to particular embodiments and with reference to certain drawings, but the invention is not limited thereto. The drawings described are only schematic and are non-limiting. In the drawings, the size of some of the elements may be exaggerated or not drawn to scale for illustrative purposes.

It will be understood that the terms “vertical” and “horizontal” are used herein refer to particular orientations of the Figures and these terms are not limitations to the specific embodiments described herein.

Furthermore, the terms “first”, “second”, “third” and the like in the description, are used for distinguishing between similar elements and not necessarily for describing a sequential or chronological order. The terms are interchangeable under appropriate circumstances and the embodiments of the invention can operate in other sequences than described or illustrated herein.

Moreover, the terms “top”, “bottom”, “over”, “under” and the like in the description are used for descriptive purposes and not necessarily for describing relative positions. The terms so used are interchangeable under appropriate circumstances and the embodiments of the invention described herein can operate in other orientations than described or illustrated herein.

The term “comprising” should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof Thus, the scope of the expression “a device comprising means A and B” should not be limited to devices consisting of only components A and B. It means that with respect to the present invention, the only relevant components of the device are A and B.

Energy harvesting is the process of converting unused ambient energy into usable electrical power. Harvesting ambient energy from mechanical vibrations or radio frequency (RF) signals is very attractive for tire pressure measurement systems (TPMS). Additionally, it is also very important for systems which do not allow battery replacement or wired power coupling. A power management module is needed for converting the highly irregular energy flow from the energy harvester or from the micro-power module into regulated energy suitable for charging a storage device, for example, a lithium (Li) battery or a super-capacitor, or for powering the TPMS electronics directly. A complete TPMS has more functional blocks besides a micro-power module as will be described in more detail below. An acceleration and/or pressure sensor device will capture the tire movement and pressure information. An analogue-to-digital converter (ADC) and microprocessor or microcontroller is used for transforming these measurements into digital information. A radio module provides communication with external receivers.

In accordance with some disclosed embodiments, a micro-power system and a method for operating a micro-power system will be described below, the micro-power system being integrated in a monitoring system to provide the electrical power required for operating the monitoring sensor device.

Although some embodiments will be described with reference to TPMS, it is not limited to such an application and other applications and implementations are possible.

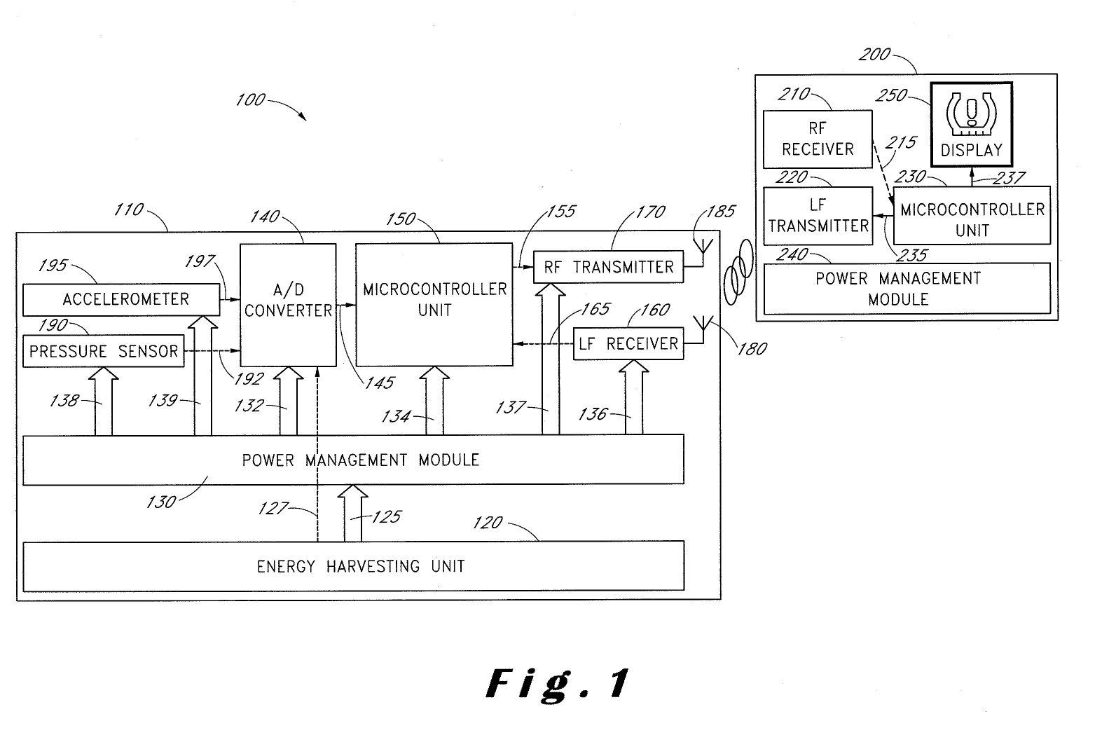

The micro-power system comprises a harvesting unit and a power management circuit containing an integrated storage element for storing energy from the harvesting unit. This is described in more detail below with reference to FIG. 1. The harvesting unit may be flexible, that is, a strain gauge, or may comprise a micro-electromechanical system (MEMS) device. The micro-power system is integrated in a single flexible package whereby the harvesting/scavenging unit may be operated using energy derived from electrostatic or piezoelectric systems together with radio frequency (RF) energy.

In one embodiment of a micro-power system, there is a tire pressure monitoring system (TPMS) used in the automotive industry for monitoring, among other parameters, the vehicle tire pressure. In this particular field of application, it is of great importance to design a micro-power system which not only provides the required system power, but also provides other functionality, including sensing and “wake-up”, that is, activation of the entire monitoring sensor system. In accordance with some embodiments, area overhead and power consumption can be reduced thus providing a more integrated solution for a TPMS.

In accordance with some embodiments, the micro-power system exhibits the following characteristics.

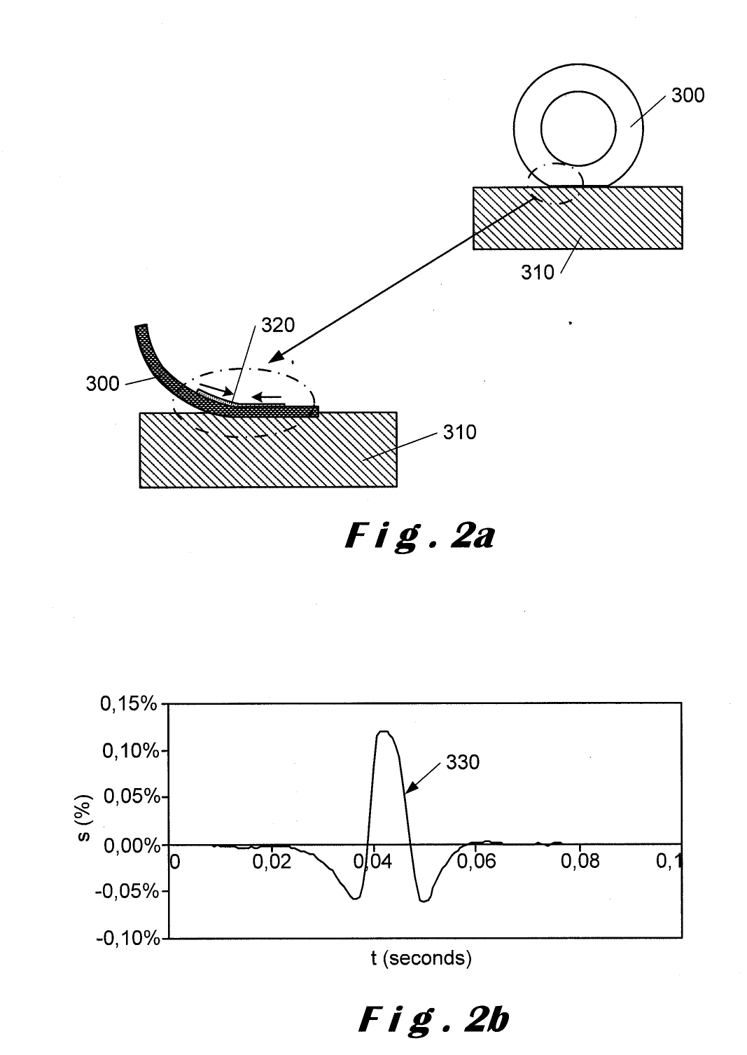

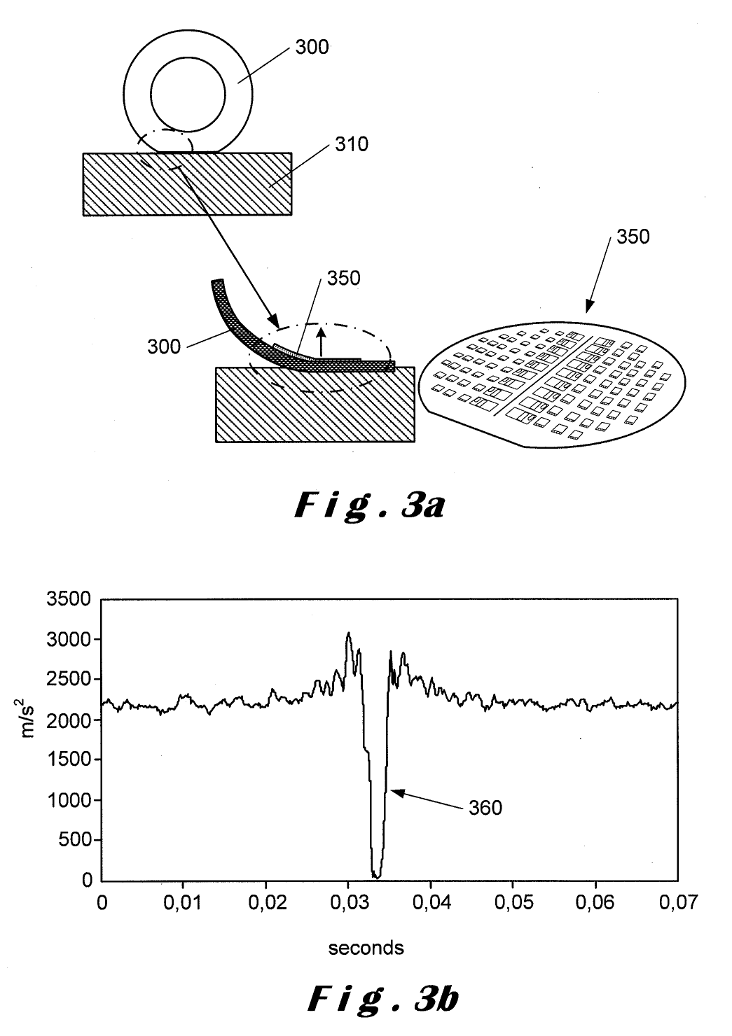

(i) The micro-power system comprises a vibrational scavenging unit mountable on or inside the tire. The vibrational scavenging unit may comprise a flexible device operating as a strain gauge and/or a MEMS device operating as an impact gauge. The operation of such devices will be described in more detail below with reference to FIGS. 2a, 2b, 3a and 3b. During motion of the tire along a road surface, this micro-power system supplies the entire monitoring system with power. For example, the harvester unit may be a piezoelectric energy harvester. The electrodes of the vibrational energy harvester may also be used as an RF harvester as will be described in more detail below. This micro-power system harvester unit supplies the sensor with the required power at low-speeds and/or immediately after the engine is switched on.

(ii) The electrodes of the vibrational energy harvester may additionally be used as antennas. In this case, the need for an external antenna component is eliminated which contributes to reduction in the system volume.

(iii) In one embodiment, the signal generated by the self-powered sensor may be used to determine the vehicle speed. This contributes to a reduction of the TPMS system power consumption and eliminates the need for separate acceleration measuring sensors, for example, accelerometers.

(iv) In another embodiment, the signal generated by the self-powered sensor system itself acts as a “wake-up” signal for the entire TPMS module. This contributes to a reduction of the TPMS power consumption and eliminates the need for external “wake-up” units, for example, a low-frequency (LF) wake-up unit.

(v) The signal generated by the self-powered sensor for determining the vehicle speed may be used in combination with other systems existing in the vehicle to determine the tire localization, that is, the identification of each tire on the vehicle. This contributes to a reduction of the TPMS power consumption and eliminates the need for external sensors, for example, RF identification (RFID) sensors and/or LF interrogators.

In FIG. 1, a first embodiment of a TPMS 100 is shown. The TPMS 100 comprises an energy harvesting module 110 which harvest power due to contact between the tire (not shown) and a road surface (also not shown). The energy harvesting module 110 includes an energy harvesting unit 120, a power management module 130, an analog-to-digital converter (ADC) 140, a microcontroller unit 150, a low frequency (LF) receiver 160 and an RF transmitter 170. The LF receiver 160 has an associated antenna element 180, and the RF transmitter 170 has an associated antenna element 185. In this embodiment, a pressure sensor 190 and an accelerometer 195 are also associated with the energy harvesting module 110.

The pressure sensor 190 and the accelerometer 195, the ADC 140, the microcontroller 150 and LF receiver 160 are connected to a power management module 130 which is powered by the energy harvesting unit 120. The microcontroller unit 150 includes a memory (not shown) and other firmware (also not shown) necessary for operation of the energy harvesting module 110. The energy harvesting module 110 may be implemented as an integrated circuit (IC) including the various elements described above.

The TPMS 100 also includes a computing device 200 located at a suitable position within a vehicle whose tires are being monitored. The computing device 200 includes a RF receiver 210, a LF transmitter 220, a microcontroller unit 230, a power management module 240 and a display 250. The RF receiver 210 and LF transmitter 220 each has an associated antenna (not shown). The computing device 200 may form part of a management control system (not shown) for the vehicle.

As shown in FIG. 1, signals are transmitted wirelessly between the RF transmitter 170 and RF receiver 210 and between the LF transmitter 220 and LF receiver 160 using respective ones of the antennas 180, 185 in the energy harvesting module 110 and the antennas associated with the computing device 200 (not shown).

When the vehicle is stationary and the tire in which the energy harvesting module 110 is located is not moving, the TPMS 100 becomes non-operational, for example, goes into a “sleep mode”. The LF transmitter 220 transmits a “wake-up” signal to the energy harvesting module 110 via the LF receiver 160 when the engine of the vehicle is switched on, so that it is effectively switched between the “sleep mode” and an “operational mode”. The RF transmitter 170 in the energy harvesting module 110 transmits energy and data relating to the power generated by the energy harvesting unit 120 to the computing device 200 via the RF receiver 210 when in the energy harvesting module 110 is in its “operational mode”.

As shown, the energy harvesting unit 120 provides power to the power management module 130 as indicated by power line 125. The power management module 130, in turn, supplies power to the ADC 140, the microcontroller 150, the LF receiver 160, the RF transmitter 170, the pressure sensor 190 and the accelerometer 195 by means of power lines 132, 134, 136, 137, 138, 139.

Data is transferred from the energy harvesting unit 120 to the ADC 140 using a data transfer line 127. The data is converted into digital form and is supplied to the microcontroller 150 on data line 145. The microcontroller 150 provides data to the RF transmitter 170 for transmission to the computing device 200 along data line 155, and receives data from the LF receiver 160 along data line 165.

In addition, data is also transferred from the pressure sensor 190 and the accelerometer 195 to the ADC 140 via respective data lines 192, 197. The converted pressure sensor data and accelerometer data is passed to the microcontroller 150 for processing, for transmission to the computing device 200 and for storage in the memory (not shown).

In the computing device, the power management module 240 provides power to each of the RF receiver 210, the LF transmitter 220, the microcontroller 230 and the display 250 (not shown). In addition, data is transferred from the RF receiver 210 to the microcontroller 230 along data line 215, and from the microcontroller 230 to the LF transmitter 220 and display 250 along respective data lines 235, 237 as shown.

The micro-power system or energy harvesting module of the present invention is integrated into a single package, which includes a power generation circuit, a unit for energy conversion and storage. As a result, the micro-power system is more robust, and, thus more reliable, due to its resistance to high temperatures and external forces, such as, acceleration, that can be generated in the specific location where the monitoring system is placed. In the case of a TPMS system as described above with reference to FIG. 1, reliability is considered as one of the important specifications of the device.

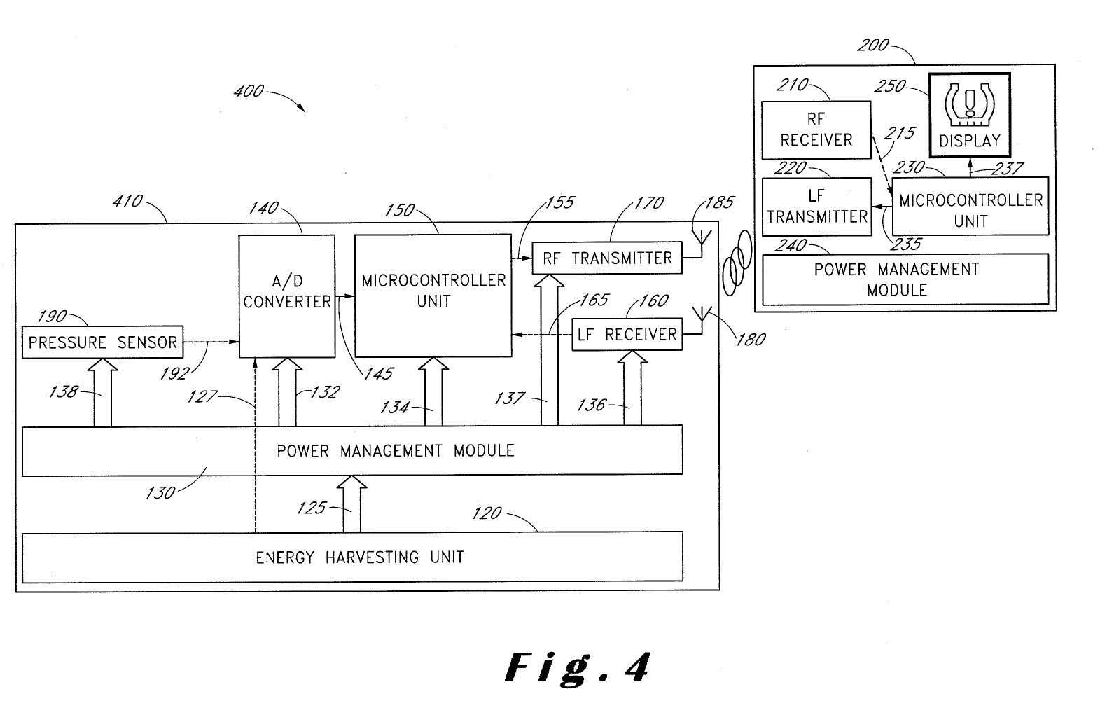

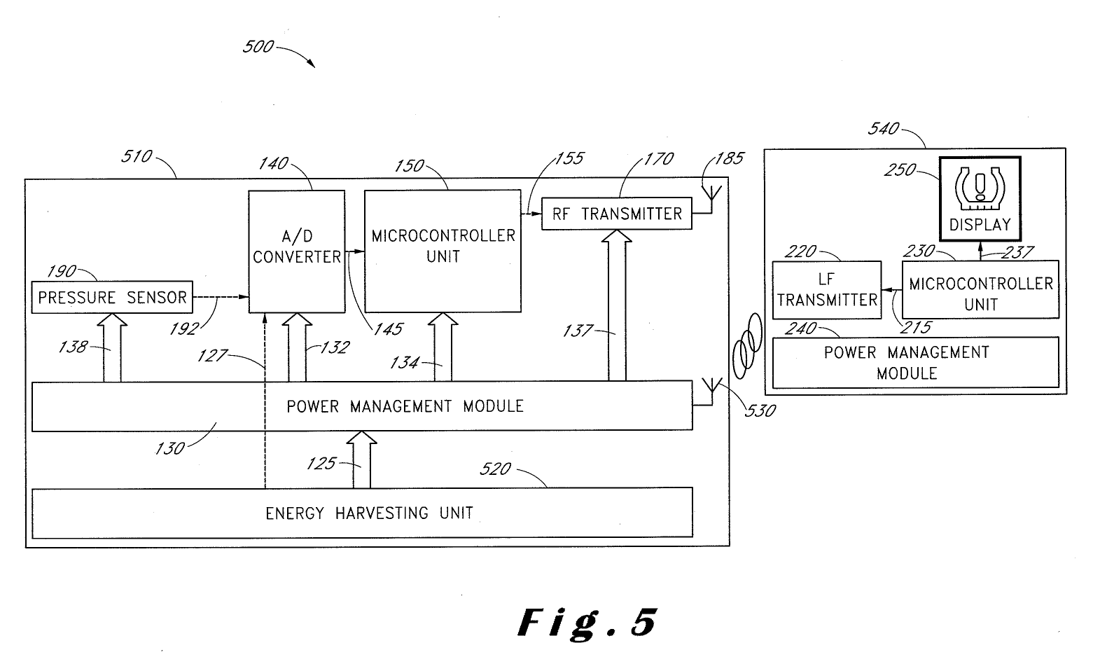

In one embodiment of the system shown in FIG. 1, once the vehicle speed is above, for example, 20km/h, 40km/h or any other suitable speed, a signal may be transmitted from the microcontroller 230 on the computing device 200 through the LF communication link, namely, LF transmitter 220 and LF receiver 160, to the microcontroller 150 on the TPMS to switch the system from a “sleep mode” to an “operational mode”. In the operational mode, the TPMS measures tire pressure information with the pressure sensor 190 at periodic intervals, for example, every 5 or 10 seconds or any other suitable time period. As described above, these measurements are processed by the ADC 140 and microcontroller 150 before transmitting the data wirelessly to the computing device 200. The data may be transmitted at regular intervals, for example, every 1 to 5 minutes or any other period of time. This functionality is maintained in the systems that will be described in more detail below with reference to FIGS. 4 and 5.

In one embodiment, the micro-power system can be used as part of a TPMS further having a sensor unit with at least one sensor for measuring at least temperature, pressure or acceleration/forces of the tire. In this case, the energy harvesting unit generates power preferably by mechanical motion, that is, according to a rotation of the tire and RF power generated by an external RF power source. The difference between the strain and impact signals on a MEMS device or flexible vibrational harvesting means, respectively, is highlighted in FIGS. 2a, 2b, 3a and 3b and is described in more detail below. Furthermore, due to the tire vibrations during motion, the vibrational harvester means offers the best harvester solution for integration in a battery-less TPMS during motion of the vehicle. Further, for no-motion situations or when the motion is too low to generate sufficient energy but still sensing information is needed, an RF beam can be used to power the integrated RF-piezoelectric harvester/sensor module.

In FIG. 2a, a schematic illustration of a tire 300 on a road surface 310 is shown. In this embodiment, energy harvesting is achieved using strain measurements. As shown, as the tire 300 contacts the road surface 310, it deforms. This deformation is detected by the micro-power system, in particular a TPMS. An energy harvesting unit 320 in the form of a piezoelectric strain gauge is located on the inside of the tread of the tire as shown. Every time the tire contacts the road, that is, once per revolution of the tire, the piezoelectric strain gauge is deformed, that is, increases in length and generates a strain pulse as shown in FIG. 2b.

In FIG. 2b, a graph of strain (in percentage (%) increase and % decrease) against time is shown. A strain pulse 330 is generated each time the tire and its associated piezoelectric strain gauge are deformed. Naturally, as the tire rotates, the portion of the tire associated with the strain gauge contacts the road surface each revolution of the tire and therefore a series of strain pulses is generated for the energy harvesting.

Although the strain pulse 330 only has a short duration, typically 40 ms, for each revolution, it is sufficient to generate micro-power energy to power a TPMS. Moreover, although only one piezoelectric strain gauge is shown in FIG. 2a, it will be appreciated that a plurality of such piezoelectric strain gauges can be provided across the width of the tread of the tire and/or on the inside of the sidewall of the tire (not shown).

In FIG. 3a, the tire 300 is again shown in contact with the road surface 310. In this case, impact of the tire 300 on the road surface 310 is measured. In a similar way to that described above with reference to FIG. 2a, an impact element 350 is mounted within the tire 310. The impact element 350 generates an impact pulse 360 (FIG. 3b) each time the portion of the tire 300 on which the element 350 attached makes contact with the road surface 310. The impact element 350 comprises a plurality of resonating elements that resonate in response to each impact pulse 360 and therefore creates resonance in the impact element 350. This resonance generates the power for the micro-power system.

In FIG. 3b, a graph of acceleration (in m/s²) against time is shown. As shown, impact pulse 360 typically has a duration of few milliseconds but is sufficient to generate micro-power energy to power a TPMS.

Both the piezoelectric strain gauge forming the energy harvesting unit 320 and the impact element 350 are considered to be vibration-based harvesting units.

It will be appreciated that the RF and energy harvesting units may be fabricated and integrated as separate systems. However, both the RF and energy harvesting units may be fabricated in a single device where the vibration-based harvester electrodes can also be used as an RF harvester.

The power management circuit will convert the energy flow from the harvesting unit in energy suitable to directly power the load. In this case, the energy harvesting and storage units can be used as an accelerometer measurement system as will be described below with reference to FIG. 4. The vehicle motion and speed may be detected by comparing the voltage generated by the energy harvesting unit with a certain voltage threshold value. As a result, extra accelerometer components are not required because detection of the motion is achieved through power generation. This advantageously contributes to a much lower power consumption, smaller size and lower weight of the complete TPMS.

In FIG. 4, a second embodiment of a TPMS 400 is shown which is similar to the TPMS 100 described with reference to FIG. 1. Components which have previously been described with reference to FIG. 1 have the same reference numerals and will not be described again in detail. The difference between the TPMS 400 shown in FIG. 4 and the TPMS 100 shown in FIG. 1 is that no accelerometer is present in energy harvesting module 410. As described above, vehicle motion and speed can be determined and used as a basis to determine acceleration of the vehicle, for example, by measuring the change in vehicle speed with respect to time. As described above with reference to FIG. 1, data provided from the energy harvesting unit 120 is passed to the ADC 140 where it is converted before being passed to the microcontroller 150. The microcontroller 150 uses the data supplied together with a clock signal generated by an internal clock (not shown) to determine the acceleration of the tire and hence the vehicle itself. This determined acceleration data is then passed to the RF transmitter 170 for transmission to the microcontroller 230 in the computing device 200 via RF antenna 185 and RF receiver 210.

The energy harvesting module and storage units may also be used as a “wake-up” system when the vehicle is in motion as described in more detail below with reference to FIG. 5. A “wake-up” system can be implemented by detecting the vehicle motion and comparing the voltage generated by the energy harvesting unit with a certain voltage threshold. As a result, an external wake-up unit is not required because wake-up is done through the power generation. Again, this contributes to a much lower power consumption, smaller size and lower weight of the complete TPMS.

In FIG. 5, a third embodiment of a TPMS 500 is shown. The TPMS 500 is similar to the TPMS 400 and components that have previously been described with reference to the TPMS 400 of FIG. 4 have the same reference numerals and are not described again here. As described above, “wake-up” is determined using the energy harvesting unit 120 which generates a voltage signal as soon as the vehicle starts moving and the TPMS 500 can then be powered up accordingly. The TPMS 500 comprises an energy harvesting module 510 which has no LF receiver 160. In addition, a computing device 540 without the LF transmitter 220 is also included.

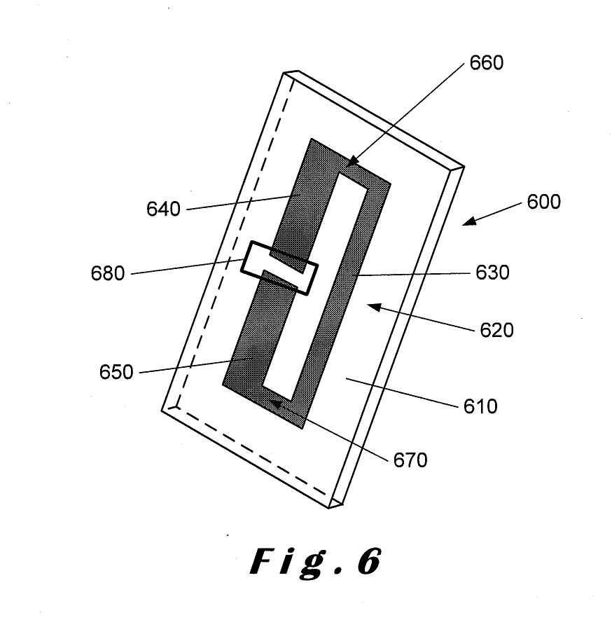

In this embodiment, the energy harvesting module 510 has an energy harvesting unit 520 which includes an antenna 530 that operates both for vibrational energy harvesting and for RF energy harvesting. Such an antenna is described in more detail below with reference to FIG. 6. Data transfer from the energy harvesting module 510 to the computing device 540 may still be made using an RF communication link provided by RF transmitter 170 and RF receiver 210.

However, if a harvesting device as described with reference to FIG. 6 below is utilized, antenna 185 becomes redundant and antenna 530 is used for the RF communication link with the RF receiver 210. In this case, processed data passed to RF transmitter 170 for transmission to the computing device 540 is directed to the antenna 530 in the energy harvesting unit 520 over a data line (not shown).

The energy harvesting and storage units may also be used for tire localization when the vehicle is in motion. The tire localization may be performed by combining voltage generation data, provided by the energy harvesting unit for waking-up the TPMS system and for determining the vehicle speed, with the information relating to wireless signal strength received from other systems in the vehicle. By using the present invention this way, a separate tire localization unit is not required contributing to a lower power consumption, smaller size and lower weight of the complete TPMS.

In addition, some embodiments of the TPMS has the additional benefit of being able to provide high data communication rates representative of the tire status, the temperature and so on, which is used as input for active safety systems in the vehicle with which the TPMS is associated. For the application in TPMS, the piezoelectric-RF system generates energy for the electronics during the complete life-time of a tire. The energy delivered by the energy harvesting unit enables also more functionality, for example, faster pressure sampling, calibration, data communication and faster motion detection. This information together with the tire identification may also be used as input for controlling other systems as anti-locking braking systems (ABS) or electronic speed control (ESC).

An implementation of an RF harvesting device 600 is shown in FIG. 6. The device 600 comprises a dielectric base 610 on which is formed an electrode element 620. The electrode element 620 comprises a metallic foil which operates as both an antenna and a rectifier for in-tire applications. The electrode element 620 comprises a substantially rectangular element with a portion removed so that the dielectric base 610 is present between a long arm portion 630 and two shorter arm portions 640, 650 as shown. The long arm portion 630 is connected to each of the two shorter arm portions 640, 650 by transverse arms 660, 670. A gap 680 provided between the two shorter arm portions 640, 650 acts as both the antenna and the rectifier, for example, a diode bridge. In addition, the electrode element 620 may operate as a sensor which again removes the need for an external sensor component thereby reducing system volume and cost. In use, the RF harvesting device 600 may be mounted on the inner liner of the tread of the tire or on a side wall.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the invention.

What is claimed is:

1. A micro-power system, comprising:
a mechanical energy harvester unit;
a power management module for receiving power generated by the mechanical energy harvester unit; and
a radio frequency energy harvester unit, wherein the mechanical energy harvester unit and the radio frequency energy harvester unit share at least one sensor element.

2. A micro-power system according to claim 1, wherein the mechanical energy harvester unit comprises at least one strain gauge.

3. A micro-power system according to claim 2, wherein each strain gauge comprises a metallic foil formed on a dielectric substrate.

4. A micro-power system according to claim 3, wherein each strain gauge includes an antenna.

5. A micro-power system according to claim 3 wherein each strain gauge includes a rectifier.

6. A micro-power system according to claim 4 wherein each strain gauge includes a rectifier.

7. A tire pressure measurement system, comprising:
a micro-power system, comprising
a mechanical energy harvester unit;
a power management module for receiving power generated by the mechanical energy harvester unit; and
a radio frequency energy harvester unit; wherein the mechanical energy harvester unit and the radio frequency energy harvester unit share at least one sensor element;
at least one pressure sensor configured for location within a tire;
a first processor for processing signals output from each pressure sensor;
a second processor configured for mounting on a vehicle; and
at least one communications link between the first processor and the second processor.

8. A tire pressure measurement system according to claim 6, wherein the second processor comprises part of a computing device.

9. A tire pressure measurement system according to claim 7, wherein the communications link comprises a radio frequency link, the first processor comprises a radio frequency transmitter for transmitting data indicative of tire pressure measurements, and the second processor comprises a radio frequency receiver for receiving the data from the first processor.

10. A tire pressure measurement system according to claim 8, wherein the communications link comprises a radio frequency link, the first processor comprises a radio frequency transmitter for transmitting data indicative of tire pressure measurements, and the second processor comprises a radio frequency receiver for receiving the data from the first processor.

11. A tire pressure measurement system according to claim 7 wherein the communications link comprises a low frequency link for transmitting control signals from the second processor to the first processor.

12. A tire pressure measurement system according to claim 8, wherein the communications link comprises a low frequency link for transmitting control signals from the second processor to the first processor.

13. A tire pressure measurement system according to claim 9, wherein the communications link further comprises a low frequency link for transmitting control signals from the second processor to the first processor.

14. A tire pressure measurement system according to claims 10, wherein the communications link further comprises a low frequency link for transmitting control signals from the second processor to the first processor.

15. A tire pressure management system comprising:
a pressure sensor configured to sense the pressure of a tire;
a computing device configured to receive and interpret information relating to the pressure of the tire;
means for communicating information between the pressure sensor and the computing device; and
means for harvesting energy from the movement of a tire, wherein the harvested energy is supplied to the pressure sensor and the means for communicating between the pressure sensor and computing device.
